(19) United States
(12) Patent Application Publication
(10) Pub. No.: US 2021/0365302 A1
(43) Pub. Date: Nov. 25, 2021

(54) ADAPTIVE AND DISTRIBUTED TUNING SYSTEM AND METHOD

(71) Applicant: Hewlett Packard Enterprise Development LP, Houston, TX (US)

(72) Inventors: Klaus-Dieter Lange, Houston, TX (US); Nishant Rawtani, Bangalore Karnataka (IN); Mukund Kumar, Bangalore Karnataka (IN); Varadarajan Sahasranamam Srinivasan, Bangalore Karnataka (IN)

(21) Appl. No.: 16/878,238

(22) Filed: May 19, 2020

(51) Int. Cl. G06F 9/50; G06F 9/455; G06F 9/30; G06F 9/445; G06F 11/34; G06F 11/30; G06N 20/00

(52) U.S. Cl. CPC G06F 9/5083; G06F 9/45558; G06F 9/3009; G06F 2009/4557; G06F 11/3409; G06F 11/3006; G06N 20/00; G06F 9/44505

(57) ABSTRACT

An Adaptive and Distributed Tuning System (ADTS) includes a distributed framework for full-stack performance tuning of workloads. Given a large search space, the framework leverages domain-specific contextual information, in the form of probabilistic models of the system behavior, to make informed decisions about which configurations to evaluate and, in turn, distribute across multiple nodes to converge rapidly to best possible configurations.

### BACKGROUND

Datacenter infrastructure has become more complex with new hardware features, and datacenter management software has grown more multi-faceted in order to facilitate the latest market trends, such as hybrid cloud datacenters, application awareness, and intent driven networking. Moreover, the ever-changing workload dynamics of next-generation workloads, including artificial intelligence (AI) and “big data,” only increase the complexity of the entire datacenter solution. This fast-moving landscape renders the performance and energy-efficiency tuning for any given workload extremely difficult, especially with the continued emphasis on reducing development cost. This creates a need to automate some of this work via auto-tuning algorithms. Generally, auto-tuning algorithms do not discover optimizations; rather, they search through a well-defined search space for a variety of known optimizations. Furthermore, available auto-tuners are tightly coupled with a small subset of the complete solution stack, e.g., OpenTuner for Compiler optimizations. This tight coupling makes the tuning framework very complex, as it requires the datacenter management software to identify, evaluate, integrate, and maintain a large number of publicly available auto-tuners. Additionally, these auto-tuners, developed by different open source communities, would work in silos and neglect the tuning overlap between the different layers of the system.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a high-level view of an exemplary system as described herein;

FIG. 2 illustrates an example of a first portion of the system of FIG. 1;

FIG. 3 illustrates an example of a second portion of the system of FIG. 1;

FIG. 4 illustrates an example of a third portion of the system of FIG. 1;

FIG. 5 illustrates an example of a fourth portion of the system of FIG. 1;

FIG. 6 illustrates an example of a fifth portion of the system of FIG. 1;

FIG. 7 illustrates an example of a process as described herein;

FIG. 8 diagrammatically illustrates an exemplary computing device and environment;

FIG. 9 illustrates one embodiment of a system employing a data center; and

FIG. 10 illustrates another embodiment of a system employing a data center.

### DETAILED DESCRIPTION OF EXEMPLARY EMBODIMENTS

Referring to the drawing figures, like reference numerals designate identical or corresponding elements throughout the several figures.

The singular forms “a,” “an,” and “the” include plural referents unless the context clearly dictates otherwise. Thus, for example, reference to “a solvent” includes reference to one or more of such solvents, and reference to “the dispersant” includes reference to one or more of such dispersants.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

For example, a range of 1 to 5 should be interpreted to include not only the explicitly recited limits of 1 and 5, but also to include individual values such as 2, 2.7, 3.6, 4.2, and sub-ranges such as 1-2.5, 1.8-3.2, 2.6-4.9, etc. This interpretation should apply regardless of the breadth of the range or the characteristic being described, and also applies to open-ended ranges reciting only one end point, such as “greater than 25,” or “less than 10.”

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

In general terms, a system as described herein includes a knowledge base of probabilistic models which represents non-overlapping tuning subsets, compiled from a historical database of performance engineering results for computing devices, e.g., servers on a network, which enables the system to drive auto-tuning in parallel on multiple systems.

Performance benchmarks for computing devices, e.g., network servers, generally have long execution times. Given the large search space (hundreds of options across hardware, platform firmware, OS, and applications, e.g., Java Virtual Machine (VM)) it is not practically feasible for an auto-tuner to converge and provide optimal tunes in a reasonable amount of time when executed serially. While this creates an opportunity to parallelize an auto-tuning process, it should be ensured that the overlap of interactions between these tunes is not lost when parallelizing auto-tuning.

The distributed nature of the framework should take a comprehensive approach which identifies, e.g., with analyses of historical results available by using classification type of machine learning models, and distributes the search space. This may be conducted so that each subset of the search space is completely disjointed and has no overlap from another subset identified in the search space. Systems and methods described herein thus include mechanisms that allow easy integration of auto-tuners, enabling not only the horizontal scaling of such auto-tuners but also may provide complete control over tuning the system at a granular level, including but not limited to CPU, memory, and network- and storage-IO.

“Auto-tuning” is an empirical, feedback-driven performance optimization technique that can be performed at all levels of a computing device's, e.g., server's, firmware and software stack in order to improve server performance. With the growing complexity of servers and their increasing number of parts, the performance of servers is directly associated with realizing the patterns of interactions amongst these elements and the overlap that exists for these interacting patterns. Auto-tuning, therefore, has emerged as a pivotal strategy to improve server performance.

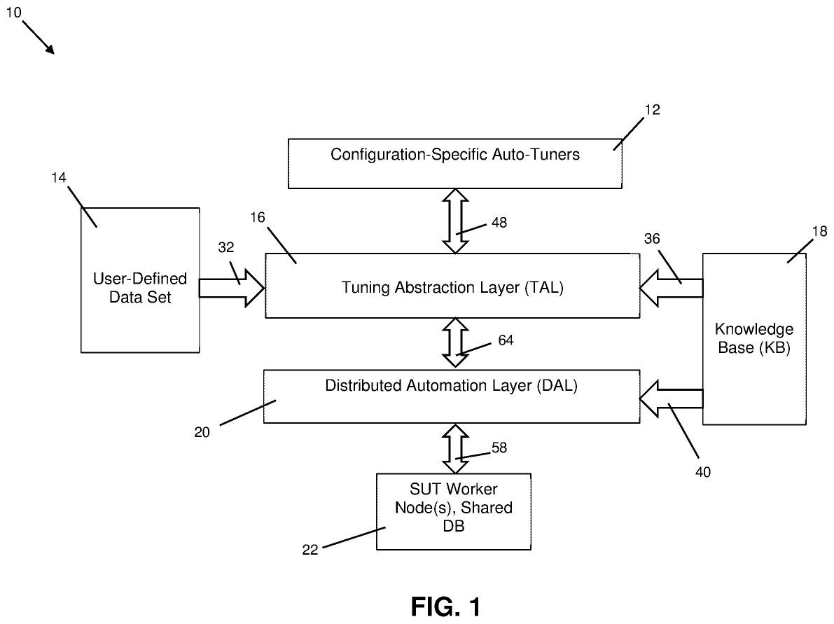

Systems and processes as described herein may include an Adaptive and Distributed Tuning System (ADTS) for full-stack tuning of workloads, which may function across hardware, firmware, OS, and/or applications, built from an aggregate of auto-tuners. A framework may be built on a data-driven programming paradigm, and may allow easy integration of publicly available, as well as brand-specific, auto-tuners. A distributed framework as described herein scales well horizontally and may allow auto-tuning to run on multiple systems in parallel. To intelligently drive the auto-tuners, probabilistic models may be built, which may include non-overlapping tuning subsets, for a knowledge base from historical data of performance tuning history derived from prior networks. ADTS may enable performance and server efficiency measurements at scale with a large scope of applications, while also discovering tunings faster. An exemplary ADTS as described herein may include a distributed framework for full-stack performance tuning of workloads. Given a particular search space, the framework may leverage domain-specific contextual information, which may include probabilistic models of the system behavior, to make informed decisions about which configurations to evaluate and, in turn, distribute across multiple nodes to converge rapidly to improved, e.g., best possible, configurations. FIG. 1 illustrates a high-level view of an exemplary architecture of an ADTS 10.

An exemplary ADTS 10 may include configuration-specific auto-tuners 12, a user-defined data set 14, and a knowledge base 18, all of which communicate data (32, 36, 48) with a tuning abstraction layer (TAL) 16, and all of which may be as described elsewhere herein. The ADTS 10 may also include a distributed automation layer (DAL) which is in data communication with the knowledge base 18 (40) and the TAL 16 (64), as well as with (58) one or more system(s) under test (SUT) worker nodes and/or a shared database 22, also described in greater detail elsewhere herein.

An exemplary ADTS 10 as described herein may provide a sophisticated method of decoupling an auto-tuner from a sub-system it is designed to operate upon, with the TAL 16. TAL 16 may convert complex problem-specific tunable parameters to one or more tuner-specific inputs. By way of several non-limiting examples, such complex problem-specific tunable parameters may include, in the case of a compiler, (gcc) flags could be ‘early-inlining-insns’ whose values can range from (0, 1000). Yet further integer examples include a flag for optimization levels denoted by ‘opt_level’, the value of which can range from (0, 3). Another example may be an enumerator parameter, e.g., ‘branch-probabilities’, which can values of on, off, and default. And, similarly, another kind of parameter may be a Boolean parameter, having values of 0 or 1, e.g., JVM flag −XX:+UseLargePages is set to 1.

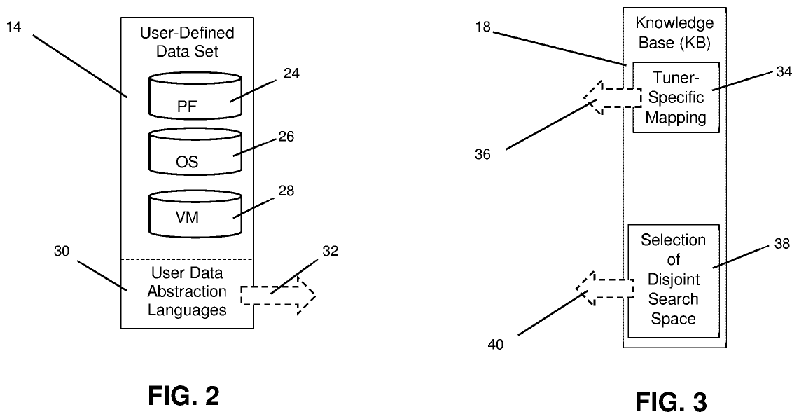

With reference to FIG. 2, this may be achieved by obtaining data, e.g., meta-data, from the user and the auto-tuner designer using a User Data Abstraction Language 30 and Tuner Abstraction Language (see FIG. 1), one or both of which may be described using human- and machine-readable languages, e.g., XML or JSON. By way of a non-limiting examples, a virtual machine (VM), e.g., a JVM, may have either a flag that works like a switch with on and off modes (e.g., −XX:+UseLargePages) or may contain a range of values (e.g., −Xmx20 g). Similarly, platform firmware, e.g., BIOS, UEFI, could have either or both of these properties. TAL 16 may be implemented using a Data Driven Programming paradigm to allow easy integration of new auto-tuners, with minimal logic changes to the framework. In an exemplary implementation, user-defined data set 14 may include data from platform firmware 24, operating system(s) 26, virtual machine(s) 28, and the like, and communicates 32 data from the data set 14 with TAL 16.

With reference to FIG. 3, compiled domain-specific performance data Knowledge Base (KB; 18) may automatically build a probabilistic model based on historical data of the functioning of the computing device(s) in order to predict one or more performance targets for a specific computing device(s), e.g., server, configuration. KB 18 may be built once per server generation due to a large number of feature modifications. According to an exemplary embodiment, the one or more probabilistic models may be created in the form of a decision tree, e.g., as a Random Forest Regressor, on top of which multicollinearity algorithms are performed. Many probabilistic models have previously been developed and are publicly available in the literature, may be used, including models which actually use standard and/or conditional probability distributions of events happening, for predicting an outcome/target (e.g., performance score, or an energy-efficiency benchmark metric, system utilization level, throughput, latency or power level with a particular workload).

Yet further examples of algorithms which may be used include gradient boosted trees (xgboost, adaboost).

The feature set (e.g., tunable parameters) may be used as inputs to the decision tree and helps to rank these features. This may assist in selecting optimal search spaces 38 on which to auto-tune by discarding those parameters which do not contribute much to the performance. Moreover, multicollinearity algorithms may assist in identifying disjoint configuration subsets, which may allow parallelizing the auto-tuning tasks across multiple nodes to efficiently converge. As a non-limiting example, a simple description of a Java application as an aggregate of probabilistic models (based on their associated tuning subsets) may include: Concurrency subset, Heap subset, Garbage Collection (GC) subset, JIT subset, and/or Platform subset. KB 18 may also include tuner-specific mapping 34, which is communicated 36 to the TAL 16.

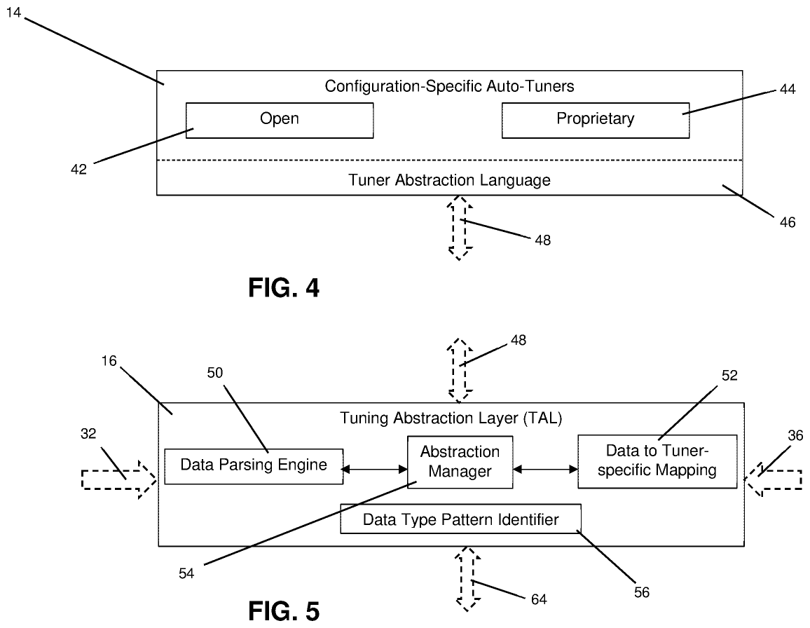

With reference to FIG. 4, configuration-specific auto-tuners 12 may include one or more of open source auto-tuners (e.g., OpenTuner, HetroCV, Auto-Tuning Framework ATF) and proprietary, brand-specific auto-tuners 44. In an exemplary embodiment, output(s) of the configuration-specific auto-tuners 12 may be converted or otherwise transcribed into a tuner abstraction language 46, which may then be communicated to the TAL 16.

With reference to FIG. 5, an exemplary TAL 16 may include a data parsing engine 50 and a data-to-tuner-specific mapping module 52, both in data communication with an abstraction manager 54. TAL 16 may also include a data type pattern identifier 56. Data parsing engine 50 may be responsible for parsing data provided by the TAL 16 and the User Data Abstraction Language 30 and convert them into data structures that can be processed by the remaining modules, e.g., code. Data Type Pattern Identifier 64 may read the data structures created by the data parsing engine 50 and identify the data type for each tunable parameter, such as boolean or a range of value. Data-to-tuner specific mapping 52, given the data type identified by Data type pattern identifier 64, may map the tunable to the appropriate entry point for the tuning auto-tuning process. Abstraction manager 54 is responsible for orchestrating all the activities of TAL 16.

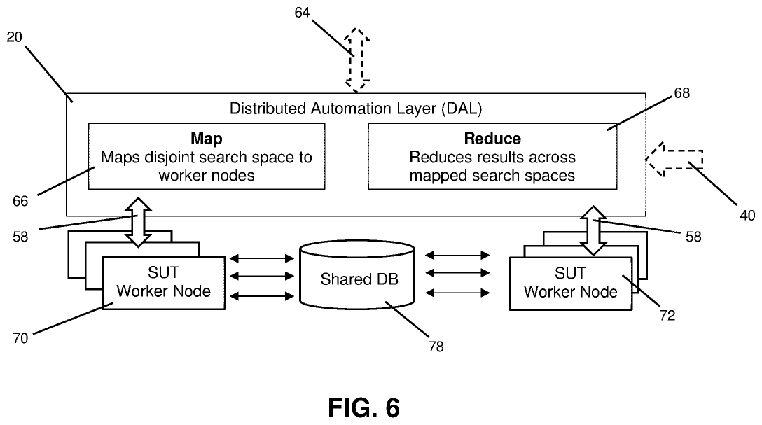

With reference to FIG. 6, an exemplary Distributed Automation Layer (DAL) 20 as described herein may enable integration of auto-tuners with large search spaces by holistically distributing configurations search spaces to multiple target systems. A DAL 20 may be implemented as a map (66)-reduce(68) task, in which a Master Node may be responsible for dividing search spaces and mapping them across its worker nodes. More specifically, a map 66 task may map disjoint search spaces to worker nodes 70, 72, and a reduce task 68 may reduce results across mapped search spaces. Distributing search spaces may be achieved by utilizing probabilistic models from KB 18. Disjoint search spaces 38 are mapped 58 to the SUT 70, 72 as a tuning task, and every individual worker node 70, 72 stores its performance results into a Shared Database 78. Based on these individual performance results, a next phase may be spawned by the driver after publishing an improved, which may be a best, configuration obtained in a previous phase. Finally, results may be reduced 68 across all worker nodes 70, 72 to determine improved tuning parameters, which may be the best tuning parameters.

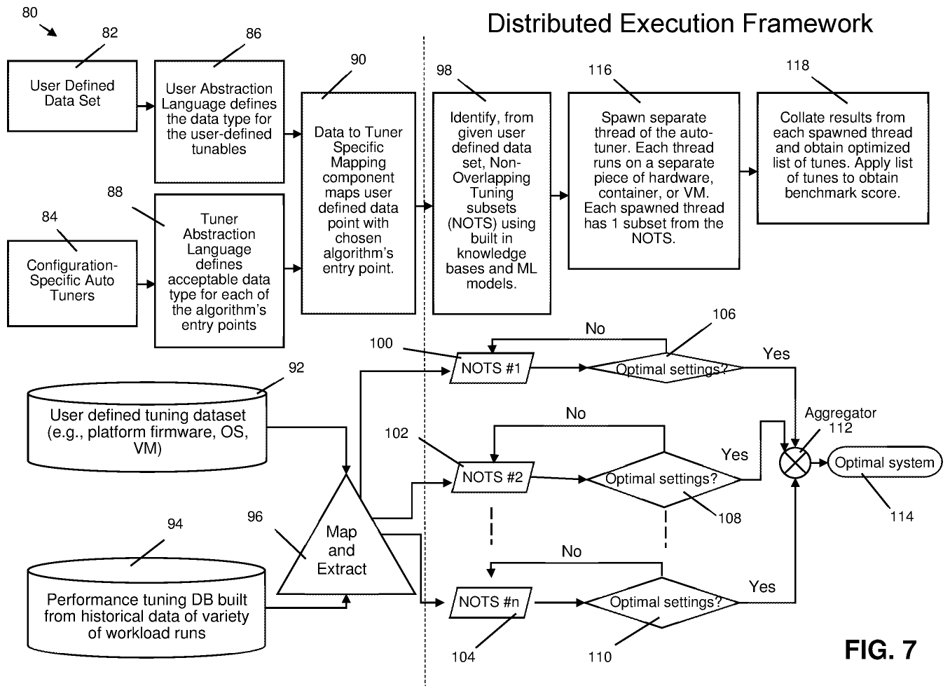

With more specific reference to FIG. 7, an exemplary process 80 is illustrated. User defined data set 82, 92 which may be data set 14, may be fed to a user abstraction language 86 which defines a data type for user-defined tunable parameters (tunables), while configuration-specific auto-tuners 84 data 94, built from historical data of a plurality and variety of workload runs, may be fed to a tuner abstraction language 88 which defines acceptable data type(s) for each of an algorithm's entry points. Acceptable data types may include parameters that may be boolean, integer numbers, enumeration, and the like, types which may be inputs to the algorithms of one or more specific auto-tuners. When not in one of these forms, then one or more tunable parameters may provide such that it may be represented as a supported data type, such as those listed above. A tuning algorithm may have a different flow of execution when handling a parameter which is presented as range of values as compared to boolean values. Similarly, a tunable parameter can also be classified as a range of values or a Boolean value, upon which metadata can be used to define acceptable data types for an algorithm.

A data to specific mapping component 90, 96, may map and extract user defined data point(s) with a chosen algorithm's entry point. The results then may be into a distributed execution framework. More specifically, at 98, the process 80 may identify, from given user-defined data set(s), non-overlapping tuning subsets (NOTS) 100, 102, 104, corresponding to NOTS #1, NOTS #2, . . . , NOTS #n, in which “n” is any real positive integer, using one or more of the built-in knowledge bases, which may include KB 18, and machine learning (ML) models.

As a non-limiting example, a tuning subset may include a simple description of a Java application as an aggregate of probabilistic models based on their associated tuning subsets, and may include: Concurrency subset, Heap subset, Garbage Collection (GC) subset, JIT subset, and/or Platform subset. In this example, a tuning subset may include any or all combinations of these subsets.

Two tunable parameters may be considered to be overlapping, e.g., be non-orthogonal, if a change in one or more values and/or settings of one parameter directly or indirectly changes the associated gains or reductions on the target achieved from the other tunable parameter. By way of a non-limiting example, a Java application may have four (4) JVM flags in the search space, namely, −Xmx, −XX:ParallelGCThreads, −XX:+UseNUMA, and −XX:+Inline. To improve performance of, e.g., optimize, this Java application, a balance may be kept between the −Xmx flag (which defines the heap size) and −XX:ParallelGCThreads flag (which defines the number of parallel GC threads used for a stop the world GC). If the heap size is too large and the number of parallel available GC threads is low, the Java application could have long pauses during a GC. Similarly, if the heap size is small and the number of parallel threads is large, very frequent but small GC pauses may result. The non-overlapping tunable parameters are those whose value when changed does not directly or indirectly impact the associated performance gain or reduction on the target achieved from others tunable parameters. Non-overlapping tunes may also be called orthogonal tunes. Therefore, in foregoing example, one of the solutions of a non-overlapping subset may be (−Xmx, −XX:ParallelGCThreads) as set1 and (−XX:+UseNUMA,−XX:+Inline) as sett.

Identification of NOTS may be achieved by detecting multicollinearity using coefficients of tunable parameters estimated using a regression machine learning (ML) model, which may identify overlapping and non-overlapping tunable parameters. For each NOTS #x, process 80 may then spawn a separate thread of the auto-tuner 116, and each thread may run on a separate piece of hardware, container, or virtual machine. More specifically, once some or all the non-overlapping subsets have been identified in the previous step, a new instance of the auto-tuner is launched on each separate hardware/virtualized instance. Another method of auto-tuner invocation may include providing the auto-tuner the complete sample space of the tunes. However, the generated solution may then provide only the identified non-overlapping subset to each of auto-tuner instance, as it is known that each non-overlapping subset would not interfere with another non-overlapping subset instance. In this manner, each auto-tuner may finish faster.

Each spawned thread may include one subset from all of the NOTS 100, 102, 104. The process then determines if improved, or optimal, settings 106, 108, 110 have resulted from each auto-tuner, run in parallel. Metrics which may be used to determine if settings are improved, e.g., optimized, may include one or more of: throughput (e.g. # of transactions per second); response time latency (e.g. query response from a web service or a database service); and energy efficiency (e.g., lowest level of energy consumption while delivering a desired level of throughput).

If not, then the process 80 returns to step 98 and determines a new non-overlapping tuning subset. Results are collated 118 from each spawned thread and a list of improved, or optimal, tunes is obtained. If yes, then the results are fed to an aggregator 112 for all of the improved, or optimal, results, which aggregates those results to arrive at an overall improved, or optimal, system 114. Obtaining a list of improved, or optimal, results thus may be used to obtain a benchmark score for the process 80.

### EXAMPLE

The STREAM benchmark, which is a simple, synthetic benchmark designed to measure sustainable memory bandwidth (in MB/s) and a corresponding computation rate for four simple vector kernels (Copy, Scale, Add and Triad), was run to conduct compiler flags optimizations by using the components described herein. A knowledge base for compiler flags was created using previous experience, and the compiler documentation was used to understand which flags are mutually exclusive. For a baseline, the STREAM benchmark was run with a complete subset on a single server and after 12 hours and 35 minutes (time-2-best-performance), a performance increase of 78% was measured. To verify that the solution actually shortens the time-2-best-performance, these flags were divided into two subsets and distributed the work across a two-node cluster. A solution converged on a similar performance gains just after 6 hours and 29 minutes, a 5-hour and 56-minute savings over the STREAM benchmark run.

Solutions described herein may provide an easy integration interface for multiple auto-tuner frameworks. Probabilistic models described herein, built from historical data, may enable smart and intelligent inferences to accelerate the auto-tuning process, providing faster convergence without compromising on accuracy.

In yet further embodiments, a large hardware footprint for distributed tuning may be addressed by running parallel tasks within VMs or containers on a single node. In this embodiment, the subsets may be chosen so that the results are not influenced by the choice of the runtime environment. For a fixed-work benchmark, e.g., Sysbench, rather than using the standard benchmark score, the runtimes themselves may be used as a metric, and the subset that yields the lowest runtime is chosen. These subsets may then be aggregated and run on an actual target system to determine performance in the target environment. Thus, the problem of hardware span may be reduced or minimized, by simply leveraged the scale and distributed nature of the framework, applied on specific search space subsets.

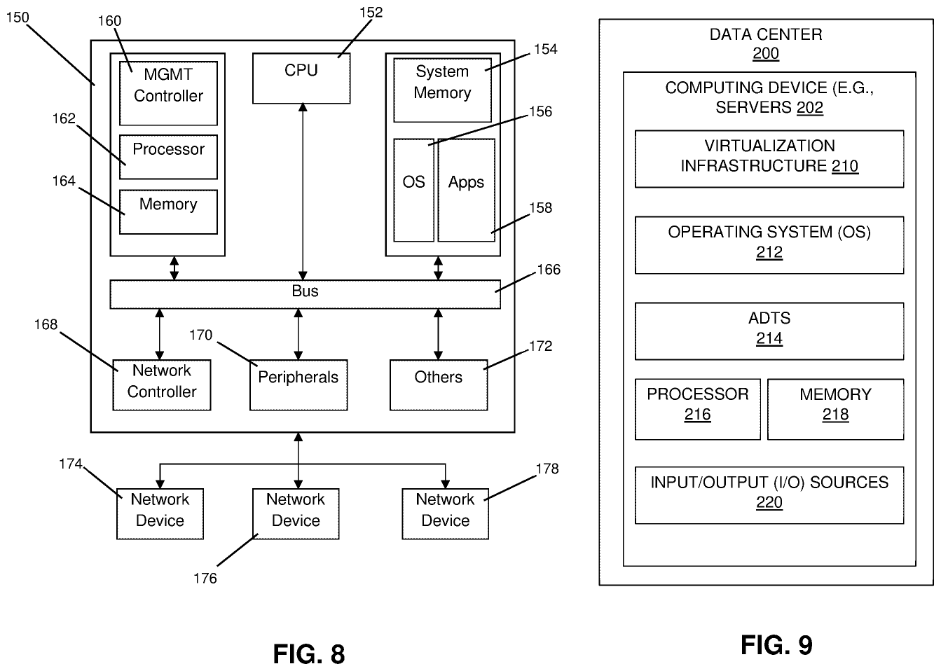

Turning again to the figures, FIG. 8 is a diagram illustrating an exemplary embodiment of a computing environment 150 which may be useful for deploying computing systems and devices such as described herein. As shown in FIG. 8, the system 150 may include a management controller 160, a processing element 152, which may be a central processing unit (CPU), a graphical processing unit (GPU), and the like, and system memory 154. In some embodiments, the system 150 may include various other hardware including a network controller 168, one or more peripheral devices 170, and other devices 172 known to those of skill in the art. The components of the system 150, including those illustrated in FIG. 8, may be connected to each other via a system bus 166 that enables communications therebetween. Management controller 160 may include a processor 162 and a memory 164, and system memory 154 may allocate space for, e.g., an operating system 156 and one or more applications 158. As discussed elsewhere herein, system 150 may be in communication on network with one or more network devices or components 174, 176, 178. It should be understood that the system 150 can include more or fewer components than those illustrated in FIG. 8. Moreover, in some embodiments, the components of system 150, such as those illustrated in FIG. 8, are provided within a single case or housing (not illustrated per se), and/or physically attached thereto.

FIG. 9 illustrates one embodiment of a data center 200 in which systems and processes as described elsewhere herein may be implemented. As shown in FIG. 9, data center 200 may include one or more computing devices 202 that may be server computers serving as a host for data center 200. In embodiments, computing device 202 may include (without limitation) server computers (e.g., cloud server computers, etc.), desktop computers, cluster-based computers, set-top boxes (e.g., Internet-based cable television set-top boxes, etc.), etc. Computing device 202 includes an operating system (“OS”) 212 serving as an interface between one or more hardware/physical resources of computing device 202 and one or more client devices, not shown. Computing device 202 further includes processor(s) 216, memory 218, input/output (“I/O”) sources 220, such as touchscreens, touch panels, touch pads, virtual or regular keyboards, virtual or regular mice, etc.

In one embodiment, computing device 202 includes a server computer that may be further in communication with one or more databases or storage repositories, which may be located locally or remotely over one or more networks (e.g., cloud network, Internet, proximity network, intranet, Internet of Things (“IoT”), Cloud of Things (“CoT”), etc.). Computing device 202 may be in communication with any number and type of other computing devices via one or more networks.

According to one embodiment, computing device 202 implements a virtualization infrastructure 210 to provide virtualization of a plurality of host resources (or virtualization hosts) included within data center 200. In one embodiment, virtualization infrastructure 210 is implemented via a virtualized data center platform (including, e.g., a hypervisor), such as VMware vSphere or Linux Kernel-based Virtual Machine. However other embodiments may implement different types of virtualized data center platforms. Computing device 202 also facilitates operation of an ADTS 214. In this exemplary embodiment, ADTS 214 is part of the SUT itself.

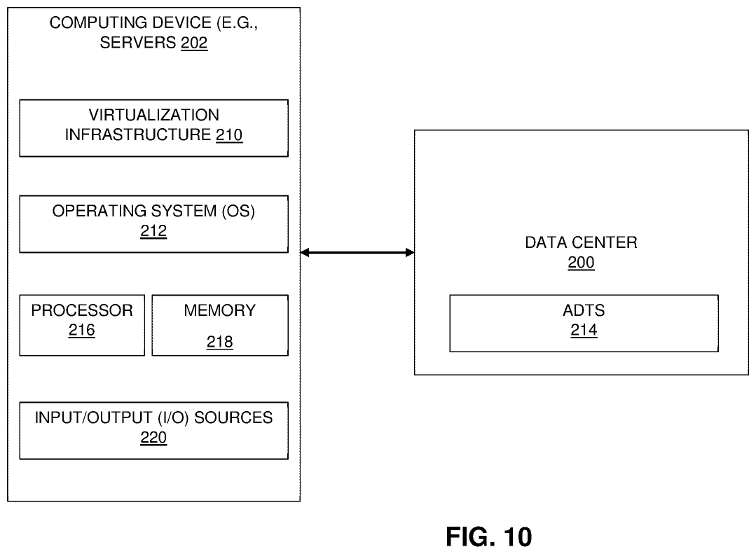

According to another exemplary embodiment, illustrated in FIG. 10, in which like reference numbers designate the same or similar features as the embodiment of FIG. 9, ADTS 214 is not part of the SUT, here computing device(s) 202, and may instead be implemented within a data center 200 which is in data communication with the SUT.

Final optimized tunes include the set of tunable parameters with their particular values, giving an improved result, which may include a best outcome and/or target, e.g., performance score, or an energy-efficiency benchmark metric, system utilization level, or power level for a set workload. By way of another non-limiting example, and with reference to the above example with hypothetical values, from set1 improved or best results are obtained for (−Xmx=29 g, −XX:ParallelGCThreads=28) and for sett (−XX:+UseNUMA set to Disabled,−XX:+Inline set to Enabled). Because it is known that the two subsets are non-overlapping, aggregating the two results using a set union method forms a final optimized tuning set of −Xmx=29 g, −XX:ParallelGCThreads=28, −XX:+UseNUMA set to Disabled,−XX:+Inline set to Enabled. This final optimized tune set is then applied to the SUT to obtain an improved, which may be the best, optimized score.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

That which is claimed is:

1. A method of performance tuning workloads based on a data set comprising user-defined data and a performance-tuning database derived from historical data of a plurality of workload runs, the method comprising:
mapping a user-defined data point from said data set with at least one entry point;
identifying from said user-defined data set at least one non-overlapping tuning subset (NOTS) based on said performance-tuning database, a machine-learning model, or both;
spawning an auto-tuner thread for each NOTS on a separate computing container; and
aggregating and collating results from each of said spawned threads, and obtaining a set of final optimized tunes.

2. A method according to claim 1, further comprising:
after said obtaining, applying said set of final optimized tunes to obtain a final performance or energy-efficiency outcome.

3. A method according to claim 1, wherein said user-defined data comprises data derived from at least one of a platform firmware, a virtual machine, and an operating system.

4. A method according to claim 1, further comprising:
defining an acceptable data type for each of said at least one entry points based on configuration-specific tuners; and
defining at least one data type for the user-defined data.

5. A method according to claim 4, wherein said mapping is based on:
said acceptable data type for each of said at least one entry points;
said at least one data type for the user-defined data; or
both.

6. A method according to claim 1, wherein said spawning an auto-tuner thread for each NOTS comprises determining if settings have resulted in better performance than before said auto-tuner thread.

7. A method according to claim 6, further comprising:
after said aggregating and collating results, applying said aggregated settings to a plurality of computing devices on a network.

8. A method according to claim 6, further comprising:
repeating said spawning with new settings values defined by each NOTS when said determined step resulted in better performance than before said auto-tuner thread; and
terminating said repeating when measured performance drops relative to a preceding iteration, or when a predetermined performance goal set for each NOTS has been achieved.

9. A system useful for performance tuning workloads based on a data set including user-defined data and a performance-tuning database derived from historical data of a plurality of workload runs, the system comprising:
a memory; and
a processing element executing instructions from the memory to
map a user-defined data point from said data set with at least one entry point;
identify from said user-defined data set at least one non-overlapping tuning subset (NOTS) based on said performance-tuning database, a machine-learning model, or both;
spawn an auto-tuner thread for each NOTS on a separate computing container; and
aggregate and collate results from each of said spawned threads, and obtain a set of final optimized tunes.

10. A system according to claim 9, said processing element further executing instructions from the memory to, after said obtaining, to apply said set of final optimized tunes to obtain a final performance or energy-efficiency result.

11. A system according to claim 9, wherein said user-defined data comprises data derived from at least one of a platform firmware, a virtual machine, and an operating system.

12. A system to claim 9, said processing element further executing instructions from the memory to:
define an acceptable data type for each of said at least one entry points based on configuration-specific tuners; and
define at least one data type for the user-defined data;

13. A system according to claim 12, wherein mapping is based on:
said acceptable data type for each of said at least one entry points;
said at least one data type for the user-defined data; or
both.

14. A system according to claim 9, wherein spawning an auto-tuner thread for each NOT comprises determining if settings have resulted in better performance than before said auto-tuner thread.

15. A system according to claim 14, said processing element further executing instructions from the memory to, after aggregating and collating results, applying said aggregated settings to a plurality of computing devices on a network.

16. A system according to claim 9, said processing element further executing instructions from the memory to:
repeat said spawning with new settings values defined by each NOTS when said determined step resulted in better performance than before said auto-tuner thread; and
terminate said repeat when measured performance drops relative to a preceding iteration, or when a predetermined performance goal set for each NOTS has been achieved.

17. A non-transitory machine-readable medium storing instructions which, when executed by a processor in communication a data set including user-defined data and a performance-tuning database derived from historical data of a plurality of workload runs, cause the processor to:
map a user-defined data point from said data set with at least one entry point;
identify from said user-defined data set at least one non-overlapping tuning subset (NOTS) based on said performance-tuning database, a machine-learning model, or both;
spawn an auto-tuner thread for each NOTS on a separate computing container; and
aggregate and collate results from each of said spawned threads, and obtain a set of final optimized tunes.

18. A non-transitory machine-readable medium according to claim 17, storing instructions which, when executed by a processor, further cause the processor to, after the processor obtains a set of final optimized tunes, apply said set of final optimized tunes to obtain a final performance or energy-efficiency outcome.

19. A non-transitory machine-readable medium according to claim 17, storing instructions which, when executed by a processor, further cause the processor to determine, when said processor spawns an auto-tuner thread for each NOTS, if settings have resulted in better performance than before said auto-tuner thread.

20. A non-transitory machine-readable medium according to claim 19, storing instructions which, when executed by a processor, further cause the processor to:
repeat said spawn with new settings values defined by each NOTS when said processor determines better performance than before said auto-tuner thread; and
terminate said repeat when measured performance drops relative to a preceding iteration, or when a predetermined performance goal set for each NOTS has been achieved.
